(19) United States
(12) Patent Application Publication
(10) Pub. No.: US 2018/0316931 A1
(43) Pub. Date: Nov. 1, 2018

(54) VIDEO COMPRESSION METHOD AND VIDEO COMPRESSION DEVICE

(71) Applicant: MStar Semiconductor, Inc., Hsinchu Hsien (TW)

(72) Inventors: Chia-Chiang HO, Hsinchu Hsien (TW); Wei-Hsiang HONG, Hsinchu Hsien (TW)

(21) Appl. No.: 15/943,834

(22) Filed: Apr. 3, 2018

(30) Foreign Application Priority Data
Apr. 27, 2017 (TW) 106114035

(51) Int. Cl. H04N 19/513; H04N 19/122; H04N 19/91; H04N 19/176

(52) U.S. Cl. CPC H04N 19/521; H04N 19/176; H04N 19/91; H04N 19/122

(57) ABSTRACT

A video compression method includes: dividing a frame into a plurality of first blocks, where a first maximum block size of the plurality of first blocks is NxN and N is a positive integer; performing a merge mode operation on the plurality of first blocks to generate a plurality of first prediction results; dividing the frame into a plurality of second blocks, wherein a second maximum block size of the plurality of second blocks is MxM and M is a positive integer smaller than N; performing motion estimation on the plurality of second blocks to generate a plurality of second prediction results; and performing video compression coding on the frame according to the plurality of first prediction results and the plurality of second prediction results.

This application claims the benefit of Taiwan application Ser. No. 106114035, filed Apr. 27, 2017, the subject matter of which is incorporated herein by reference.

### BACKGROUND OF THE INVENTION

### Field of the Invention

The invention relates in general to a video compression method and a video compression device, and more particularly to a video compression method and a video compression device for reducing complexities.

### Description of the Related Art

In response to user demands on video image quality, video compression standards have gradually developed from MPEG-2, MPEG-4, H.263 and Advanced Video Coding (AVC)/H.264 to a new-generation High Efficiency Video Coding (HEVC) standard.

In the H.264/AVC standard, a video compression device can divide a frame into same-sized macroblocks (MB) for coding. Further, a video compression device can choose intra-prediction or inter-prediction to obtain an image residual, process the image residual by discrete cosine transform (DCT) and quantization, and then code the transformed and quantized residual into a video bitstream that is then transmitted. Further, a video compression device can perform prediction for different block sizes, e.g., performing prediction on 16×16, 16×8, 8×16, 8×8, 8×4, 4×8 and 4×4 block sizes. For example, if a frame to be compressed is a flat region (having a lower texture complexity), larger blocks may be used for prediction. In contrast, if a frame to be compressed is a more complex region (having a higher texture complexity), smaller blocks may be used for prediction. In addition, motion vectors of different blocks may be designed to respectively reach ½ and ¼ accuracy levels in order to provide more accurate frame prediction.

In the recent years, the amount of data that needs to be processed is ever expanding as frame resolutions continue to increase. Video compression experts have developed, on the basis of H.264, a new-generation HEVC standard structure. The operation of HEVC video coding is substantially similar to that of H.264. FIG. 4 shows a block diagram of a video compression device 40 in an HEVC standard. Referring to FIG. 4, the video compression device 40 performs inter-prediction and intra-prediction on a frame Fn by using an inter-prediction module 400 and an intra-prediction module 402 to obtain a prediction frame Pn. The video compression device 40 compares the prediction frame Pn with an original frame Fn to be coded to obtain an image residual Rn. By using a transform and quantization module 404 and an entropy coding module 406, the video compression device 40 performs DCT, quantization and entropy decoding on the image residual Rn to generate a compressed and coded video bitstream VBS.

Compared to H.264 that divides a frame into macroblocks having a size of 16×16, the video compression device 40 based on HEVC divides the frame Fn into tree blocks having a size of 64×64 for coding. That is to say, the coding blocks divided by the video compression device 40 under an HEVC standard are larger. In addition, the video compression device 40 under an HEVC standard further uses loop filter as well as better intra-prediction and inter-prediction technologies, thus achieving better compression efficiency. However, the operation complexities of the video compression device 40 under an HEVC standard are also significantly increased.

Therefore, there is a need for a video compression method and a video compression device for reducing complexities.

### SUMMARY OF THE INVENTION

It is a primary object of the present invention to provide a video compression method and a video compression device for reducing complexities so as to overcome issues of the prior art.

The present invention discloses a video compression method including: dividing a frame into a plurality of first blocks, wherein a first maximum block size of the plurality of first blocks is N×N and N is a positive integer; performing a merge mode operation on the plurality of first blocks to generate a plurality of first prediction results; dividing the frame into a plurality of second blocks, wherein a second maximum block size of the plurality of second blocks is M×M and M is a positive integer smaller than N; performing motion estimation on the plurality of second blocks to generate a plurality of second prediction results; and performing video compression coding on the frame according to the plurality of first prediction results and the plurality of second prediction results.

The present invention further discloses a video compression device including: a merge module, performing a merge mode operation on a plurality of first blocks of a frame to generate a plurality of first prediction results, wherein a first maximum block size of the plurality of first blocks is N×N and N is a positive integer; a motion estimation module, performing motion estimation on a plurality of second blocks of the frame to generate a plurality of second prediction results, wherein a second maximum block size of the plurality of second blocks is M×M and M is a positive integer smaller than N; and a coding module, performing video compression coding on the frame according to the plurality of first prediction results and the plurality of second prediction results.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a video compression device according to an embodiment of the present invention;

FIG. 2 is a flowchart of a process of a video compression device according to an embodiment of the present invention;

FIG. 3 is a block diagram of an inter-frame prediction module according to an embodiment of the present invention; and

FIG. 4 is a block diagram of a conventional video compression device.

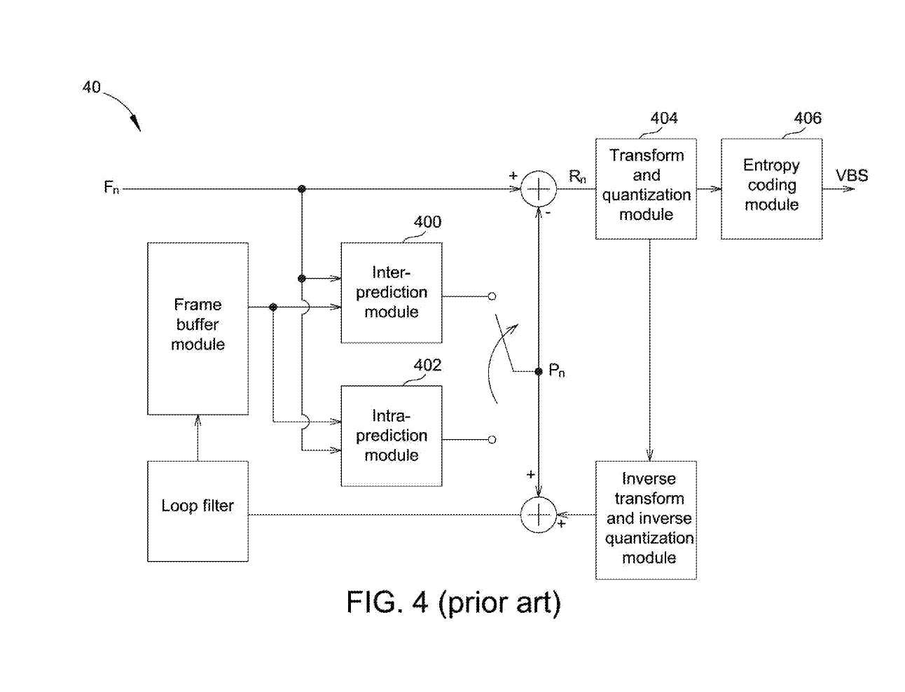

### DETAILED DESCRIPTION OF THE INVENTION

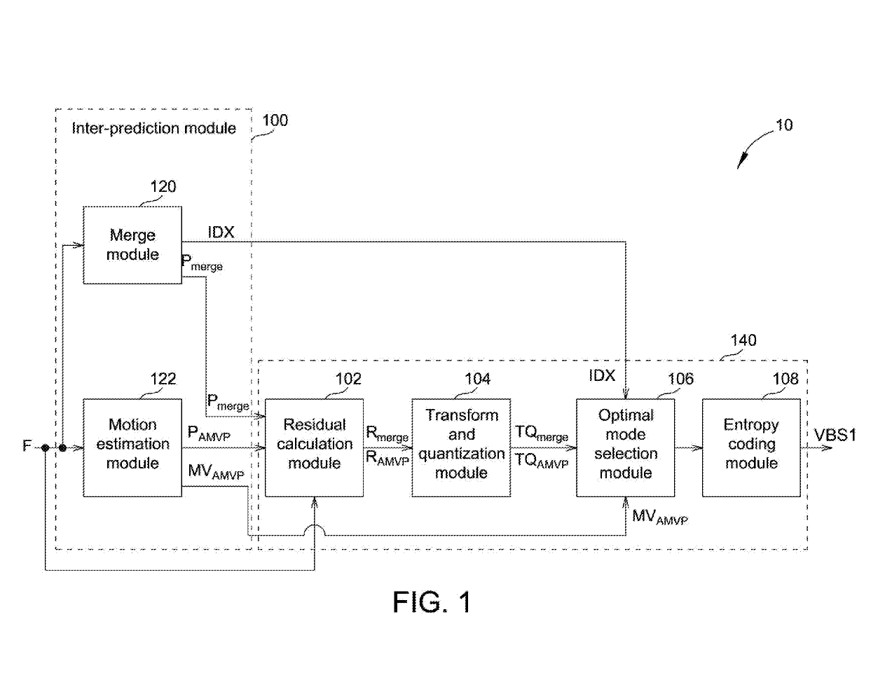

The present invention focuses on the technology for improving inter-prediction in a video coding process so as to reduce overall complexities of a video compression device. More specifically, FIG. 1 shows a block diagram of a video compression device 10 according to an embodiment of the present invention. The video compression device 10 may be a video compression device conforming to a High Efficiency Video Coding (HEVC) standard, and performs video compression coding on a non-coded video data stream. The video compression device 10 includes an inter-prediction module 100 and a coding module 140. The inter-prediction module 100 includes a merge module 120 and a motion estimation module 122. The coding module 140 includes a residual calculation module 102, a transform and quantization module 104, an optimal mode selection module 106 and an entropy coding module 108. For simplicity, only modules related to inter-prediction are depicted in FIG. 1, and modules including an intra-prediction module, an inverse transform and inverse quantization module, a loop filter and a frame buffer module needed by the video compression device 10 are omitted in FIG. 1.

The merge module 120 divides a frame F to be coded into a plurality of first blocks BK_{merge}, and performs a merge mode operation on the plurality of first blocks BK_{merge} to generate a plurality of first prediction blocks P_{merge} corresponding to the plurality of first blocks Bk_{merge}. The merge module 120 may further obtain, according to a plurality of first motion vectors MV_{merge} adjacent to the first blocks BK_{merge}, a plurality of indices IDX corresponding to the plurality of first motion vectors MV_{merge} (the plurality of prediction blocks P_{merge} or the plurality of indices IDX may correspond to a plurality of prediction results). The merge module 120 may output the plurality of first prediction blocks P_{merge} of the plurality of first blocks Bk_{merge} to the residual calculation module 102, and output the plurality of indices IDX corresponding to the plurality of first motion vectors MV_{merge} to the optimal mode selection module 106. It should be noted that, a first maximum block size of the plurality of first blocks Bk_{merge} is N×N (where N is a positive integer). For example, when the first maximum block size of the plurality of first blocks Bk_{merge} is 64×64 (i.e., when the positive integer N is equal to 64), the merge module 120 may divide the frame F into the plurality of first blocks Bk_{merge} having different sizes such as 64×64, 32×32, 16×16 and 8×8, and perform the merge mode operation on the plurality of first blocks Bk_{merge} having different sizes.

Other details of how the merge module 120 performs the merge mode operation on the plurality of first blocks Bk_{merge} are given in the description on the merge mode of the HEVC standard, and shall be omitted herein.

Further, the motion estimation module 122 divides the frame F to be coded into a plurality of second blocks BK_{AMVP}, and performs motion estimation on the plurality of second blocks BK_{AMVP} to generate a plurality of second prediction blocks P_{AMVP} corresponding to the plurality of second blocks BK_{AMVP} and a plurality of second motion vectors MV_{AMVP} corresponding to the plurality of second blocks BK_{AMVP} (the plurality of second prediction blocks P_{AMVP} or the plurality of second motion vectors MV_{AMVP} may correspond to a plurality of second prediction results). The motion estimation module 122 may output the plurality of second prediction blocks P_{AMVP} to the residual calculation module 102, and output the plurality of second motion vectors MV_{AMVP} to the optimal mode selection module 106. It should be noted that, provided that the first maximum block size of the plurality of first blocks Bk_{merge} is N×N, a second maximum block size of the plurality of second prediction blocks P_{AMVP} is M×M, where M is a positive integer and is smaller than the positive integer N. For example, when the first maximum block size of the plurality of first blocks Bk_{merge} is 64×64 (i.e., when the positive integer is 64), the motion estimation module 122 can only divide the image F into the plurality of second blocks BK_{AMVP} having a size of smaller than M×M; that is, the maximum block size of the plurality of second blocks BK_{AMVP} is M×M, where the positive integer M is smaller than 64. In one embodiment, provided that the first maximum block size of the plurality of first blocks Bk_{merge} is 64×64, the motion estimation module 122 may divide the frame F into a plurality second blocks BK_{AMVP} having difference sizes such as 32×32, 32×16, 16×32, 16×16, 16×8, 8×16, 8×8, 8×4 and 4×8, and perform the motion estimation on the plurality of second blocks BK_{AMVP} having different sizes. In one embodiment, the positive integer N is an integral multiple of the positive integer M, i.e., the positive integer N may be represented as N =jM, where j represents a positive integer (e.g., j=2).

Further, the motion estimation may be an advanced motion vector prediction (AMVP) mode operation. When the motion estimation module 122 performs advanced motion vector prediction on a block BK_k′ among the plurality of second blocks BK_{AMVP}, the motion estimation module 122 may directly generate a second motion vector MV_{AMVP} corresponding to the block BK_k′ and the second prediction blocks P_{merge}. Other details of how the motion estimation module 122 performs the motion estimation or the advanced motion vector prediction are given in the description on the AMVP mode in the HEVC standard, and shall be omitted herein.

The coding module 140 performs video compression coding on the frame F according to the plurality of first prediction blocks P_{merge}, the plurality of second prediction blocks P_{AMVP}, the plurality of indices IDX and the plurality of second motion vectors MV_{AMVP}. More specifically, the residual calculation module 102 receives the frame F, the plurality of first prediction blocks P_{merge} and the plurality of second prediction blocks P_{AMVP}, generates, according to the frame F and the plurality of first prediction blocks P_{merge}, a plurality of first residuals R_{merge} corresponding to the plurality of first prediction blocks P_{merge}, and generates, according to the frame F and the plurality of second prediction blocks P_{AMVP}, a plurality of second residuals R_{AMVP} corresponding to the plurality of second prediction blocks P_{AMVP}. Other operation details of the residual calculation module 102 are generally known to one person skilled in the art, and shall be omitted herein.

The transform and quantization module 104 performs discrete cosine transform (DCT) and quantization on the plurality of first residuals R_{merge} and the plurality of second residuals R_{AMVP} to generate a plurality of transform and quantization results TQ_{merge} corresponding to the plurality of first residuals R_{merge} and a plurality of transform and quantization results TQ_{AMVP} corresponding to the plurality of second residuals R_{AMVP}. Other operation details of the transform and quantization module 104 are generally known to one person skilled in the art, and shall be omitted herein.

The optimal mode selection module 106 receives the plurality of transform and quantization results TQ_{merge}, the plurality of transform and quantization results TQ_{AMVP}, the plurality of indices IDX and the plurality of second motion vectors MV_{AMVP}, and selects a least rate distortion (RD) cost as an optimal mode according to the transform and quantization results TQ_{merge}, the plurality of transform and quantization results TQ_{AMVP}, the plurality of indices IDX and the plurality of second motion vectors MV_{AMVP}. The entropy coding module 108 performs entropy coding on the frame F according to the optimal mode to generate a compressed and coded video bitstream VBS1 corresponding to frame F. The entropy coding module 108 may perform entropy coding on the frame F by using a context-based adaptive binary arithmetic coding (CABAC). Other operation details of the CABAC algorithm, the optimal mode selection module 106 and the entropy coding module 108 are generally known to one person skilled in the art, and shall be omitted herein.

It should be noted that, for a block having a larger block size (e.g., a 64×64 block), motion estimation requires quite high hardware complexities. Further, for a block having a larger block size (e.g., a 64×64 block), compared to the merge mode operation, motion estimation achieves a lower compression gain. In other words, if motion estimation is performed on a block having a larger block size, in addition to yielding a compression gain lower than that achieved by the merge mode operation, hardware complexities are also increased for no good cause.

In prior art, when a first maximum block size of a plurality of first blocks divided for a merge mode operation performed by a video compression device is N×N, a second maximum block size of a plurality of second blocks divided for motion estimation by the video compression device is necessarily equal to N×N. In the above situation, a conventional video compression device has higher hardware complexities. In comparison, in an embodiment of the present invention, when the first maximum block size of the plurality of first blocks BK_{AMVP} divided for the merge mode operation performed by the merge module 120 is N×N, the motion estimation module 122 is required to perform motion estimation only on the plurality of second blocks BK_{AMVP} having a block size smaller than M×M, wherein the positive integer M is smaller than the positive integer N. Thus, hardware complexities needed by the video compression device 10 can be significantly lowered, while preserving a compression gain substantially the same as that of prior art. Further, the motion estimation module 122 is capable of performing motion estimation on only the plurality of second blocks BK_{AMVP} having a block size smaller than M×M in way that the selection range of the optimal mode selection module 106 is made smaller, thus reducing the time needed for the operation of the optimal mode selection module 106.

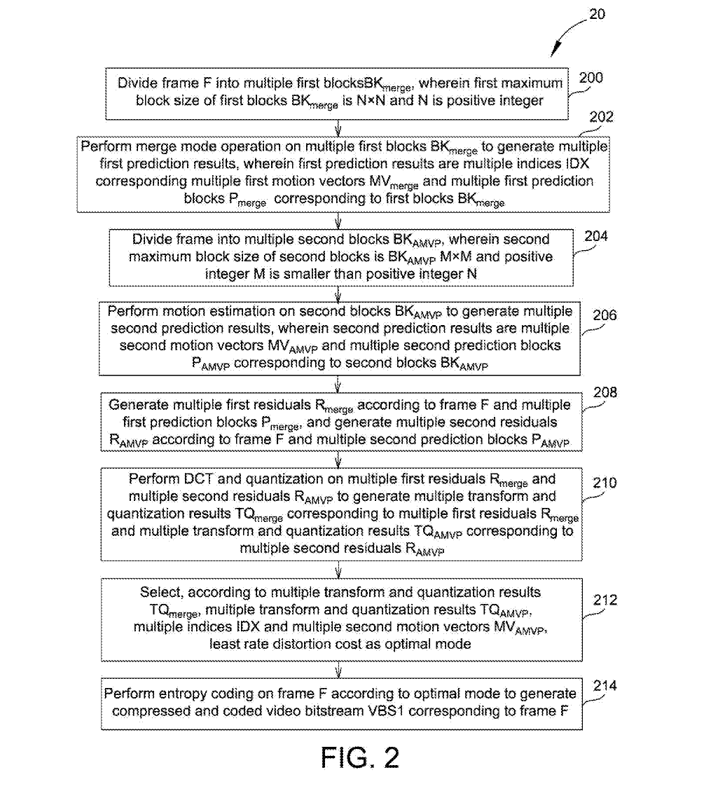

The operation of the video compression device 10 may be further concluded into a video compression process. FIG. 2 shows a flowchart of a video compression process 20 according to an embodiment of the present invention. The video compression process 20 may be performed by the video compression device, and includes following steps.

In step 200, a frame F is divided into a plurality of first blocks BK_{merge}, wherein a first maximum block size of the plurality of first blocks BK_{merge} is N×N and N is a positive integer.

In step 202, a merge mode operation is performed on the plurality of first blocks Bk_{merge} to generate a plurality of first prediction results. The plurality of first prediction results are a plurality of indices IDX corresponding to a plurality of first motion vectors MV_{merge} and a plurality of first prediction blocks P_{merge} corresponding to the plurality of first blocks Bk_{merge}.

In step 204, the frame F is divided into a plurality of second blocks BK_{AMVP}, wherein a second maximum block size of the plurality of second blocks BK_{AMVP} is M×M and the positive integer M is smaller than the positive integer N.

In step 206, motion estimation is performed on the plurality of second blocks BK_{AMVP} to generate a plurality of second prediction results. The plurality of second prediction results are a plurality of second motion vectors MV_{AMVP} corresponding to the plurality of second blocks BK_{AMVP} and a plurality of second prediction P_{AMVP} corresponding to the plurality of second blocks BK_{AMVP}.

In step 208, a plurality of residuals R_{merge} corresponding to the plurality of first prediction blocks P_{merge} are generated according to the frame F and the plurality of first prediction blocks P_{merge}, and a plurality of second residuals R_{AMVP} corresponding to the plurality of second prediction blocks P_{AMVP} are generated according to the frame F and the plurality of second prediction blocks P_{AMVP}.

In step 210, DCT and quantization are performed individually on the plurality of first residuals R_{merge} and the plurality of second residuals R_{AMVP} to generate a plurality of transform and quantization results TQ_{merge} corresponding to the plurality of first residuals R_{merge} and a plurality of transform and quantization results TQ_{AMVP} corresponding to the plurality of second residuals R_{AMVP}.

In step 212, a least rate distortion cost is selected, according to the plurality of transform and quantization results TQ_{merge}, the plurality of transform and quantization results TQ_{AMVP}, the plurality of indices IDX and the plurality of second motion vectors MV_{AMVP}, as an optimal mode.

In step 214, entropy coding is performed on the frame F according to the optimal mode to generate a compressed and coded video bitstream VBS1 corresponding to the frame F.

Operation details of the video compression process 20 may be referred from the foregoing associated description, and are omitted herein. One person skilled the in the art can appreciate that the modules and function units in FIG. 1 may be realized or implemented by digital circuits (e.g., RTL circuits) or a digital signal processor (DSP), and associated details are omitted herein.

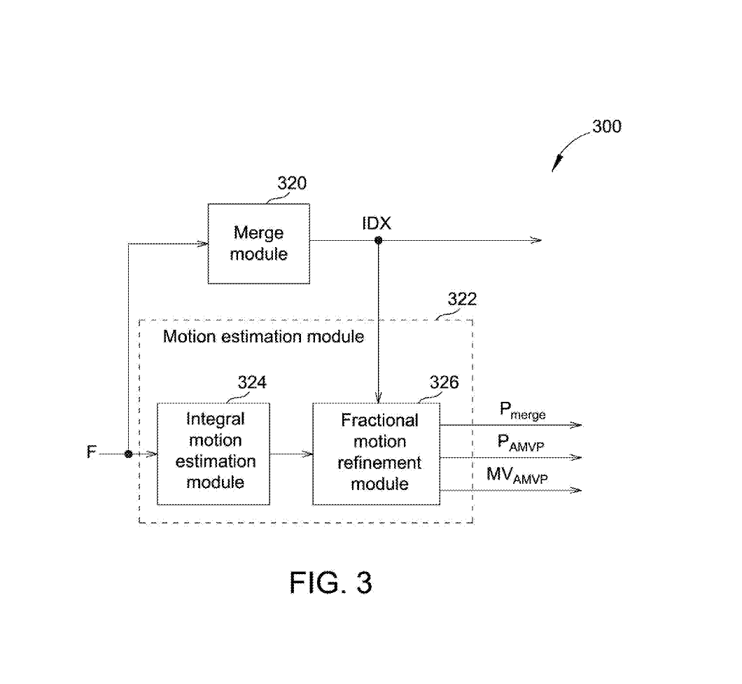

It should be noted that, the above embodiments are used for explaining the concept of the present invention, and one person skilled in the art can accordingly make appropriate modifications therefrom. For example, in the video compression device 10, the merge module 120 generates the plurality of first prediction blocks P_{merge} corresponding to the plurality of first blocks Bk_{merge}, and obtains the plurality of indices IDX corresponding to the plurality of first motion vectors MV_{merge}; however, the present invention is not limited thereto. FIG. 3 shows a block diagram of an inter-prediction module 300 according to an embodiment of the present invention. The inter-prediction module 300 includes a first merge module 320 and a motion estimation module 322. The motion estimation module 322 includes an integer motion estimation module 324 and a fractional motion refinement module 326. The inter-prediction module 300 operates similarly to the inter-prediction module 100, and differs from the inter-prediction module 100 in a respect that, compared to the merge module 100, a merge module 320 outputs only the plurality of indices IDX corresponding to the plurality of first motion vectors MV_{merge}; and compared to the motion estimation module 122, a motion estimation module 322, in addition to generating the plurality of second prediction blocks P_{AMVP} corresponding to the second blocks BK_{AMVP} and the plurality of second motion vectors MV_{AMVP} corresponding to the second blocks BK_{AMVP}, a motion vector 322 generates the plurality of first prediction blocks P_{merge} corresponding to the plurality of first blocks Bk_{merge} further by using the fractional motion refinement module 326. Provided that the first maximum block size of the plurality of first blocks Bk_{merge} for the merge mode operation performed by the merge module 320 is N×N, the motion estimation module 322 performs motion estimation only on the plurality of second blocks BK_{AMVP} having a block size smaller than M×M (wherein the positive integer M is smaller than the positive integer N), which satisfies the requirement of the present invention is encompassed within the scope of the present invention. Other operation details of the integer motion estimation module 324 and the fractional motion refinement module 326 are generally known to one person skilled in the art, and shall be omitted herein.

In conclusion, for the motion estimation process in the present invention, the second maximum block size of blocks divided from the frame to be encoded is reduced, thus lowering hardware complexities needed by the video compression device of the present invention while maintaining a compression gain substantially the same as that of prior art. More specifically, under the same coding rate, 98% to 99% of the compression gain can be preserved while saving about 20% of circuit area. Further, because the selection range of the optimal mode selection module is reduced as the second maximum block is reduced, the operation time needed by the optimal mode selection module is also shortened.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A video compression method, comprising:
dividing a frame into a plurality of first blocks, wherein a first maximum block size of the plurality of first blocks is N×N and N is a positive integer;
performing a merge mode operation on the plurality of first blocks to generate a plurality of first prediction blocks;
dividing the frame into a plurality of second blocks, wherein a second maximum block size of the plurality of second blocks is M×M and M is a positive integer smaller than N;
performing motion estimation on the plurality of second blocks to generate a plurality of second prediction results; and
performing video compression coding on the frame according to the plurality of first prediction results and the plurality of second prediction results.

2. The video compression method according to claim 1, wherein the positive integer N is an integral multiple of the positive integer M.

3. The video compression method according to claim 2, wherein the integral multiple is 2.

4. The video compression method according to claim 1, further comprising:
performing the merge mode operation on the plurality of first blocks to obtain a plurality of indices corresponding to a plurality of first motion vectors or a plurality of first prediction blocks corresponding to the plurality of first blocks as the plurality of first prediction results;
and performing the motion estimation on the plurality of second blocks to obtain a plurality of second motion vectors corresponding to the plurality of second blocks or a plurality of second prediction blocks corresponding to the plurality of second blocks as the plurality of second prediction results.

5. The video compression method according to claim 4, wherein the step of performing the video compression coding on the frame according to the plurality of first prediction results and the plurality of second prediction results comprises:
generating a plurality of residuals corresponding to the plurality of first prediction blocks according to the frame and the plurality of first prediction blocks; and
generating a plurality of second residuals corresponding to the plurality of second prediction blocks according to the frame and the plurality of second prediction blocks.

6. The video compression method according to claim 4, wherein the step of performing the video compression coding on the frame according to the plurality of first prediction results and the plurality of second prediction results comprises:
selecting an optimal mode according the plurality of indices and the plurality of second motion vectors; and
performing entropy coding on the frame according to the optimal mode to generate a video bitstream corresponding to the frame.

7. A video compression device, comprising:
a merge module, performing a merge mode operation on a plurality of first blocks of a frame to generate a plurality of first prediction results, wherein a first maximum block size of the plurality of first blocks is N×N and N is a positive integer;
a motion estimation module, performing motion estimation on a plurality of second blocks of the frame to generate a plurality of second prediction results, wherein a second maximum block size of the plurality of second blocks is M×M and M is a positive integer smaller than N; and
a coding module, performing video compression coding on the frame according to the plurality of first prediction results and the plurality of second prediction results.

8. The video compression device according to claim 7, wherein the positive integer N is an integral multiple of the positive integer M.

9. The video compression device according to claim 8, wherein the integral multiple is 2.

10. The video compression device according to claim 7, wherein the plurality of first prediction results are a plurality of indices corresponding to a plurality of first motion vectors or a plurality of first prediction blocks corresponding to the plurality of first blocks, and the plurality of second prediction results are a plurality of second motion vectors corresponding to the plurality of second blocks or a plurality of second prediction bocks corresponding to the plurality of second blocks.

11. The video compression device according to claim 7, wherein the coding module comprises:
a residual calculation module, generating a plurality of residuals corresponding to the plurality of first prediction blocks according to the frame and the plurality of first prediction blocks, and generating a plurality of second residuals corresponding to the plurality of second prediction blocks according to the frame and the plurality of second prediction blocks.

12. The video compression device according to claim 7, wherein the coding module comprises:
an optimal mode selection module, selecting an optimal mode according to the plurality of indices and the plurality of second motion vectors; and
an entropy coding module, performing entropy coding on the frame according to the optimal mode to generate a video bitstream corresponding to the frame.
